(19) United States
(12) Patent Application Publication
(10) Pub. No.: US 2014/0192565 A1
(43) Pub. Date: Jul. 10, 2014

(54) CIRCUIT WITH SYNCHRONOUS RECTIFIER FOR CONTROLLING PROGRAMMABLE POWER CONVERTER

(71) Applicant: Chou-Sheng Wang, Keelung City (TW)

(72) Inventor: Chou-Sheng Wang, Keelung City (TW)

(73) Assignee: SYSTEM GENERAL CORP., New Taipei City (TW)

(21) Appl. No.: 14/146,022

(22) Filed: Jan. 2, 2014

Related U.S. Application Data
(60) Provisional application No. 61/749,987, filed on Jan. 8, 2013.

(51) Int. Cl. H02M 3/335

(52) U.S. Cl. CPC H02M 3/33592; H02M 3/33507
USPC 363/21.14

(57) ABSTRACT

A control circuit of a power converter and a method for controlling the power converter are provided. The control circuit of the power converter comprises a switching circuit and a temperature-sensing device. The switching circuit generates a switching signal in response to a feedback signal, and the switching circuit generates a current-sensing signal for regulating an output of the power converter. The temperature-sensing device generates a temperature signal in response to temperature of the temperature-sensing device.

### CROSS REFERENCE TO RELATED APPLICATION

This application claims the priority benefits of U.S. provisional application Ser. No. 61/749,987, filed on Jan. 8, 2013. The entirety of the above-mentioned patent applications is hereby incorporated by reference herein and made a part of this specification.

### BACKGROUND OF THE INVENTION

1. Field of the Invention

The present invention relates to techniques for regulating an output voltage of a power converter, and particularly relates to a regulation circuit with synchronous rectifier (SR) for controlling a programmable power converter.

2. Related Art

A programmable power converter provides a wide range of the output voltage and the output current, such as 5V-20V and 0.5 A-5 A. In general, it would be difficult to develop a cost effective, high efficiency solution and achieve complete protection, such as over-voltage, etc. for the power converter. The object of the techniques for controlling the power converter is to solve this problem, and to develop a programmable power converter with low cost, high efficiency and good performance.

### SUMMARY OF THE INVENTION

The present invention provides a circuit for controlling a programmable power converter. The circuit comprises a control circuit, a feedback circuit, a switching controller, a synchronous rectifier, and an opto-coupler. The control circuit generates a programmable voltage-reference signal for the power converter. The feedback circuit is configured to detect the output voltage for generating a feedback signal in accordance with the programmable voltage-reference signal and the output voltage. The switching controller is configured to detect the switching current of a transformer for generating a switching signal coupled to switch the transformer for generating the output voltage and the output current in accordance with the feedback signal and the switching current of the transformer. The synchronous rectifier is coupled to the transformer for generating the output of the power converter. The opto-coupler is configured to transfer the feedback signal from the control circuit to the switching controller. The control circuit is in the secondary side of the transformer. The switching controller is in the primary side of the transformer. The control circuit generates a driving signal coupled to control the synchronous rectifier.

From another point of view, the present invention provides a method for controlling a programmable power converter.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 shows a block diagram illustrating a programmable power converter according to one embodiment of the present invention.

FIG. 2 shows a block diagram illustrating the control circuit according to one embodiment of the present invention.

FIG. 3 shows a block diagram illustrating the synchronous rectifying circuit according to one embodiment of the present invention.

FIG. 4 shows a block diagram illustrating the feedback circuit according to one embodiment of the present invention.

FIG. 5 shows a circuit diagram illustrating the protection circuit according to one embodiment of the present invention.

FIG. 6 shows a reference circuit diagram illustrating the timer according to one embodiment of the present invention.

FIG. 7 shows a block diagram illustrating the switching controller according to one embodiment of the present invention.

FIG. 8 shows a schematic circuit diagram illustrating the PWM circuit according to one embodiment of the present invention.

FIG. 9 shows a block diagram illustrating the programmable circuit according to one embodiment of the present invention.

FIG. 10 shows a block diagram illustrating the pulse-position modulation circuit in FIG. 9 according to one embodiment of the present invention.

FIG. 11 shows the waveforms of the control signals, the slope signal, the synchronous signal, the data signal and the demodulated signal according to one embodiment of the present invention.

FIG. 12 shows the waveforms of the control signals, the reset signal and the protection signal according to one embodiment of the present invention.

### DETAILED DESCRIPTION OF EMBODIMENTS

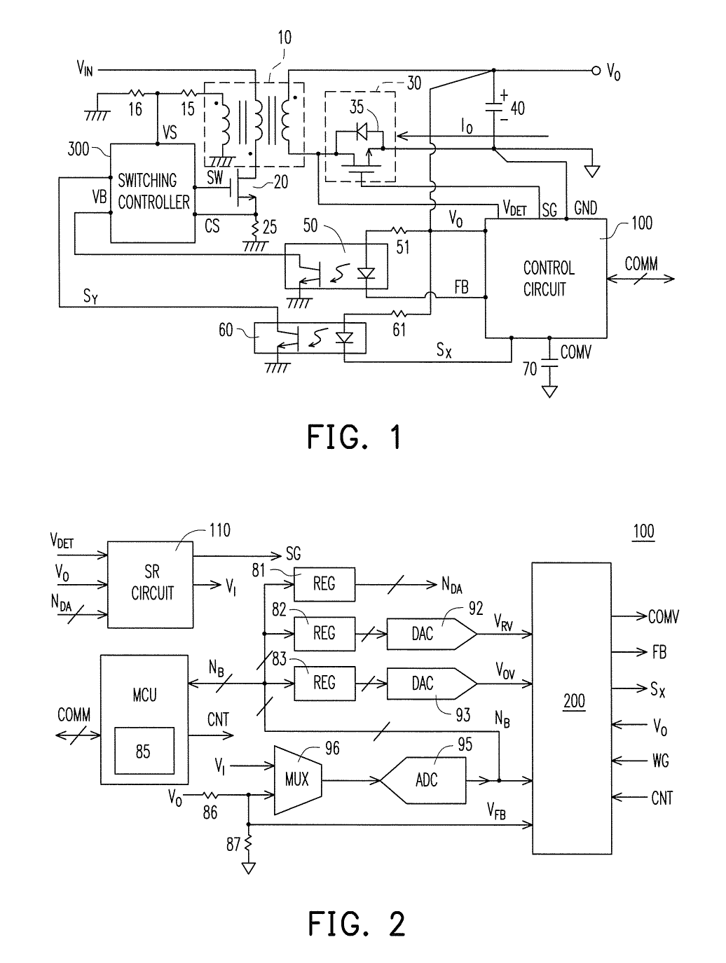

FIG. 1 shows a block diagram illustrating a programmable power converter according to one embodiment of the present invention. The programmable power converter comprises a transformer 10, a control circuit 100, a switching controller 300, a synchronous rectifier (SR) 30, and an opto-coupler 50. The programmable power converter further comprises a capacitor 70, an opto-coupler 60, resistors 51, 61, 16, and 25, and an output capacitor 40. The control circuit 100 comprises a feedback circuit. An input voltage V_{IN} is coupled to the transformer 10. The control circuit 100 is configured to detect the output voltage V_{O} for developing the feedback loop. The control circuit 100 generates a feedback signal FB coupled to the switching controller 300 through the opto-coupler 50 for regulating the output voltage V_{O}. In other words, the opto-coupler 50 transfers the feedback signal FB from the control circuit 100 to the switching controller 300. The capacitor 70 is applied to compensate the voltage feedback-loop for regulating the output voltage V_{O}. The control circuit 100 further generates a control signal S_{X} configured to control the switching controller 300 through the opto-coupler 60. The control signal S_{X} is utilized for programming of the switching controller 300 and the over-voltage protection. The resistor 51 is utilized to bias the operating current of the opto-coupler 50. The resistor 61 is utilized to limit the current of the opto-coupler 60. The control circuit 100 further comprises a communication interface COMM, (e.g., USB-PD, IEEE UPAMD 1823, one-wire communication, etc.) for the communication with the external devices, such as mobile phone, tablet-PC, Notebook-PC, etc.

The opto-couplers 50 generates a feedback signal V_{B} in accordance with the feedback signal FB. The opto-couplers 60 generates a control signal S_{Y} in accordance with the control signal S_{X}. The switching controller 300 generates a switching signal S_{W} for switching a primary winding of the transformer 10 to generate the output voltage V_{O} and the output current I_{O} at the secondary winding of the transformer 10 through a synchronous rectifier 30 and the output capacitor 40. The synchronous rectifier 30 is controlled by a synchronous rectifying driving signal S_{G}, and the synchronous rectifying driving signal S_{G} is generated by the control circuit 100. The synchronous rectifier 30 generates the output voltage V_{O} of the power converter. A transformer signal V_{DET} is generated in the secondary winding of the transformer 10 in response to turning on of the switching signal S_{W}. The transformer signal V_{DET} is coupled to the control circuit 100 for generating the synchronous rectifying driving signal S_{G}.

The transformer 10 further produces a reflected signal V_{S} in response to turning off of the switching signal S_{W}. The reflected signal V_{S} is coupled to the switching controller 300 via resistors 15 and 16. The resistor 25 is configured to sense the switching current of the transformer 10 for generating a current signal C_{S} coupled to the switching controller 300. The switching controller 300 generates the switching signal S_{W} in accordance with the feedback signal V_{B}, the control signal S_{Y}, the reflected signal V_{S} and the current signal C_{S}. In other words, the switching controller 300 detects the switching current of the transformer 10 for generating the switching signal S_{W} configured to switch the transformer 10 for generating the output voltage V_{O} and an output current I_{O} of the power converter in accordance with the feedback signal F_{B} and the switching current S_{W} of the transformer 10. The control circuit 100 is coupled to the secondary side of the transformer 10. The switching controller 300 is coupled to the primary side of the transformer 10.

FIG. 2 shows a block diagram illustrating the control circuit 100 according to one embodiment of the present invention. The control circuit 100 comprises an embedded micro-controller (MCU) 80, a synchronous rectifying circuit 110, registers 81-83, digital-to-analog converters 92-93, an analog-to-digital converter (ADC) 95, a multiplexer (MUX) 96, and the feedback circuit 200. The embedded micro-controller 80 comprises a memory 85. The micro-controller 80 generates a programmable voltage-reference signal (i.e., a control signal CNT) and a control-bus signal N_{B} for the power converter. The control-bus signal N_{B} is a bi-directional (input/output) transmission. The micro-controller 80 comprises the communication interface COMM to communicate with the external devices, such as the host and/or the I/O devices. The control-bus signal N_{B} is utilized to control the analog-to-digital converter (ADC) 95, the multiplexer (MUX) 96, registers 81, 82, and 83 and digital-to-analog converters (DAC) 92 and 93. The digital-to-analog converters 92- and 93 are controlled by the embedded micro-controller 80 through the control bus signal N_{B} and the registers 82 and 83. The register 81 generates a digital code N_{DA} coupled to control the synchronous rectifying circuit 110. The synchronous rectifying circuit 110 generates the SR driving signal S_{G} and an input-voltage signal V_{I} in response to the transformer signal V_{DET}, the output voltage V_{O} and the digital code N_{DA}. The level of the input-voltage signal V_{I} is correlated to the level of the input voltage V_{IN} of the power converter in FIG. 1.

A voltage divider is formed by the resistors 86 and 87 for generating a feedback signal V_{FB} in accordance with the output voltage V_{O}. The feedback signal V_{FB} is coupled to the analog-to-digital converter 95 through the multiplexer 96. The input-voltage signal V_{I} is also coupled to the analog-to-digital converter 95 through the multiplexer 96. Therefore, via the control-bus signal N_{B}, the micro-controller 80 can read the information of the output voltage V_{O} and the input voltage V_{IN} of the power converter. The micro-controller 80 controls the output of the digital-to-analog converters 92, 93 by the registers 82, 83 and the control-bus signal N_{B}. The digital-to-analog converter 92 generates a reference signal V_{RV} for controlling the output voltage V_{O}. The digital-to-analog converter 93 generates an over-voltage threshold V_{OV} for the over-voltage protection. The micro-controller 80 controls the over-voltage threshold V_{OV} in accordance with the level of the output voltage V_{O}. The registers 81, 82, and 83 will be reset to the initial value in response to the power-on of the control circuit 100. For example, the initial value of the register 82 will produce a minimum value of the reference signal V_{RV} that generates a 5V of the output voltage V_{O}.

The feedback circuit 200 detects the output voltage V_{O} of the power converter to generate a voltage-feedback signal COMV, the feedback signal FB and the control signal S_{X} in accordance with the reference signal V_{RV}, the over-voltage threshold V_{OV}, the output voltage V_{O}, the feedback signal V_{FB} and the control signal CNT.

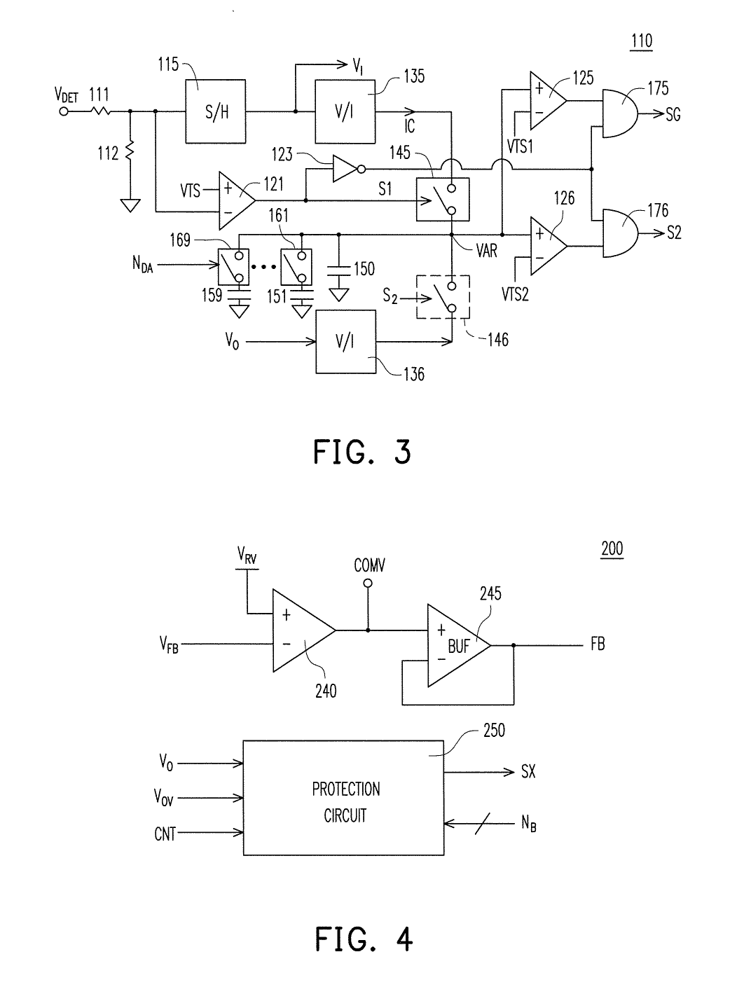

FIG. 3 shows a block diagram illustrating the synchronous rectifying circuit 110 according to one embodiment of the present invention. The synchronous rectifying circuit 110 includes resistors 111, 112, a sample-and-hold circuit (S/H) 115, comparators 121, 125, and 126, voltage-to-current converters (V/I) 135 and 136, an inverter 123, capacitors 150-159, and switches 145-146, and 161-169. The transformer signal V_{DET} is coupled to the sample-and-hold circuit (S/H) 115 through resistors 111 and 112. The sample-and-hold circuit 115 generates the input-voltage signal V_{I} in response to the sample of the transformer signal V_{DET}. The voltage-to-current converter 135 generates a charge current I_{C} in accordance with the input-voltage signal V_{I}. The voltage-to-current converter 136 also generates a discharge current I_{D} in accordance with the output voltage V_{O}. The charger current I_{C} is configured to charge a capacitor array by a switch 145. The discharger current I_{D} is configured to discharge the capacitor array by a switch 146. The capacitor array is formed by the capacitors 150-159 and switches 161-169. The switches 161-169 are controlled by the digital code N_{DA}. The comparator 121 enables a signal S₁ to turn on the switch 145 when a voltage-divided signal of the transformer signal V_{DET} is higher than a threshold V_{TS}. When the signal S₁ is disabled, the comparator 126 will enable a signal S₂ to turn on the switch 146 by an AND gate 176 and the inverter 123 if the voltage VAR on the capacitor array is higher than a threshold V_{TS2}. Furthermore, when the signal S₁ is disabled, the comparator 125 will generate the SR driving signal SG by an AND gate 175 and the inverter 123 if the voltage VAR on the capacitor array is higher than a threshold V_{TS1}. The capacitance of the capacitor array will be programmed by the micro-controller 80 in response to the programming of the output voltage V_{O}.

FIG. 4 shows a block diagram illustrating the feedback circuit 200 according to one embodiment of the present invention. The feedback circuit 200 comprises an error amplifier 240, a buffer (BUF) 245, and a protection circuit 250. The error amplifier 240 generates the voltage-feedback signal COMV in accordance with the feedback signal V_{FB} and the reference signal V_{RV}. The voltage-feedback signal COMV is connected to the capacitor 70 in FIG. 1 for the loop-compensation. The voltage-feedback signal COMV is further connected to a buffer 235 for generating the feedback signal FB. In other words, the buffer 235 generates the feedback signal FB in accordance with the voltage-feedback signal COMV. The output of the buffer 245 is the open-drain structure. The protection circuit 250 receives the control-bus signal N_{B} and generates the control signal SX in accordance with the over-voltage threshold V_{OV}, the output voltage V_{O} and the control signal CNT.

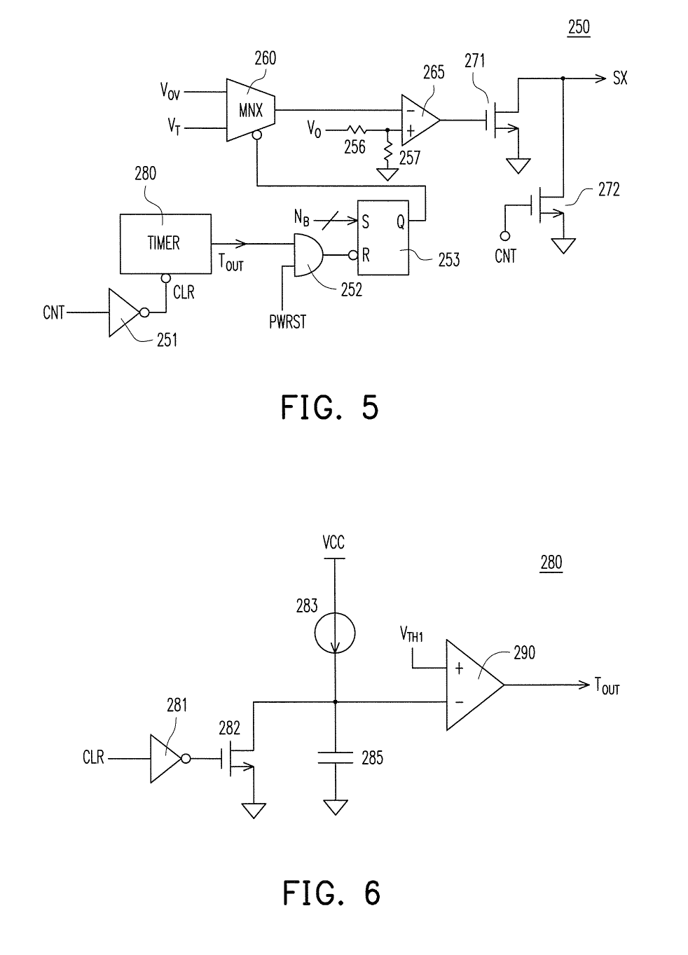

FIG. 5 shows a circuit diagram illustrating the protection circuit 250 according to one embodiment of the present invention. The protection circuit 250 comprises a timer 280, an inverter 251, an AND gate 252, a flip-flop 253, a multiplexer 260, a comparator 265, transistors 271 and 272, and resistors 256 and 257. The inverter 251 receives the control signal CNT to generate an input signal CLR, and the timer 251 (e.g., watch dog timer) is cleared by receiving the input signal CLR. The timer 280 generates an expiration signal T_{OUT} if the control signal CNT is not generated periodically. The expiration signal T_{OUT} and a power-on reset signal PWRST are configured to reset the flip-flop 253. The flip-flop 253 is set by the micro-controller 80 through the control-bus signal N_{B}. The over-voltage threshold V_{OV} and a threshold V_{T} are coupled to the comparator 265 through the multiplexer 260. The multiplexer 260 is controlled by the flip-flop 253. When the flip-flop 253 is set, the over-voltage threshold V_{OV} will be connected to the comparator 265. If the flip-flop 253 is reset, the threshold V_{T} will be connected to the comparator 265 for the over-voltage protection. The output voltage V_{O} is coupled to the comparator 265 through the resistors 256 and 257. A ver-voltage protection of this embodiment is programmable by the micro-controller 80 through programming the level of the over-voltage threshold V_{OV}, and the over-voltage threshold will be reset as a minimum value if the control signal CNT is not generated in time periodically. For example, the over-voltage threshold V_{OV} will be programmed to 14V for a 12V output voltage V_{O}, and the threshold V_{T} will be programmed to 6V for the 5V output voltage V_{O}. If the control signal CNT is not generated by the micro-controller 80 timely, the over-voltage threshold V_{OV} will be reset to 6V even when the output voltage V_{O} is set as 12V. The situation described above will protect the power converter from abnormal operation when the micro-controller 80 is operated incorrectly. The output of the comparator 265 drives the transistor 271 for generating the control signal S_{X}. The control signal CNT also drives the transistor 272 to generate the control signal S_{X}. The output of the transistors 271 and 272 are parallel connected. Thus, the control signal S_{X} is used for the protection of the power converter and the control of the micro-controller 80.

FIG. 6 shows a reference circuit diagram illustrating the timer 280 according to one embodiment of the present invention. The timer 280 comprises an inverter 281, a transistor 282, a constant current source 283, a capacitor 285, and a comparator 290. The constant current source 283 is utilized to charge a capacitor 285. The input signal CLR of the timer 280 is configured to discharge the capacitor 285 through the inverter 281 and the transistor 282. If the capacitor 285 is not discharged by the signal CLR timely, then the comparator 290 will generate the expiration signal T_{OUT} when the voltage of the capacitor 285 is charged higher than a threshold V_{TH1}.

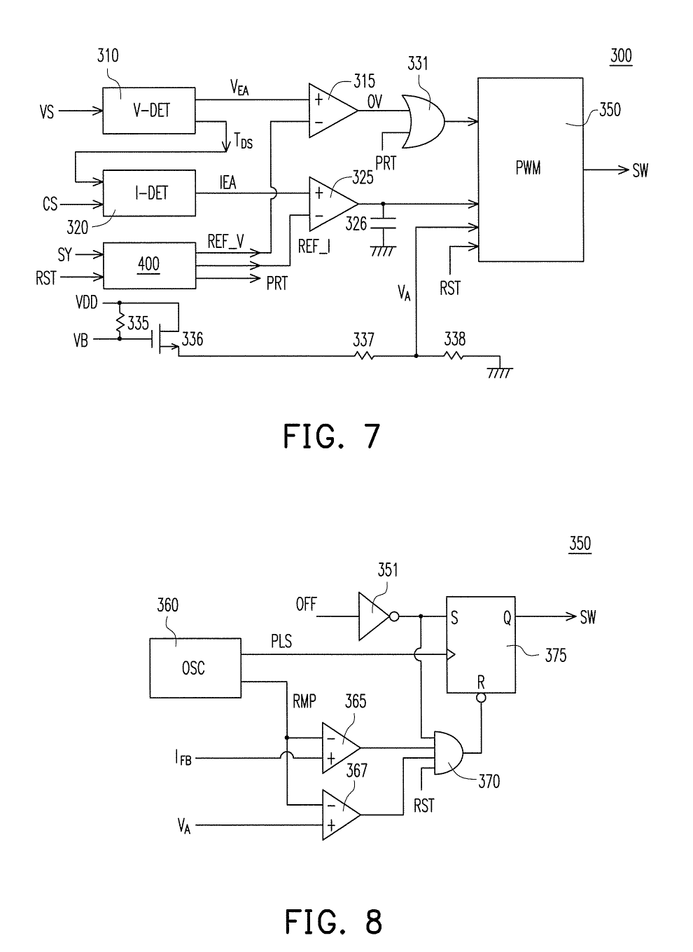

FIG. 7 shows a block diagram illustrating the switching controller 300 according to one embodiment of the present invention. The switching controller 300 comprises a voltage detection circuit (V-DET) 310, a current detection circuit (I-DET) 320, a comparator 315, an amplifier 325, an OR gate 331, a capacitor 326, resistors 335, 337 and 338, a transistor 336, a programmable circuit 400, and a PWM circuit 350. The current detection circuit 320 generates a voltage-loop signal V_{EA} and a discharge time signal T_{DS} in accordance with the reflected signal V_{S}. The voltage-loop signal V_{EA} is correlated to the output voltage V_{O}. The discharge e time signal T_{DS} is correlated to the demagnetizing time of the transformer 10. The current detection circuit 320 generates a current-loop signal I_{EA} in accordance with the current signal CS and the discharge time signal T_{DS}. The voltage detection circuit 310 and the current detection circuit 320 are related to the technology of the primary side regulation of the power converter.

The voltage-loop signal V_{EA} is coupled to a comparator 315 for generating an over-voltage signal OV when the voltage-loop signal V_{EA} is higher than a reference signal REF_V. The current-loop signal I_{EA} is coupled to the amplifier 325. The current-loop signal I_{EA} is connected to the amplifier 325 and compared with a reference signal REF_I generated by the programmable circuit 400 generates a current feedback signal I_{FB}. The capacitor 326 is coupled to the current feedback signal I_{FB} for the loop compensation. The programmable circuit 400 is configured to generate the reference signals REF_V, REF_I and a protection signal PRT in response to the control signal S_{Y} and a power-on reset signal RST. The reference signal REF_V is operated as an over-voltage threshold for the over-voltage protection. This over-voltage protection is developed by the reflected signal V_{S} detection. The reference signal REF_I is operated as a current reference signal for regulating the output current I_{O} of the power converter.

The OR gate 331 receives the protection signal PRT and the over-voltage signal O_{V} to generate an off signal OFF. The resistor 335 is utilized to pull high the feedback signal V_{B} by connecting to the power voltage V_{DD}. The transistor 336 receives the feedback signal V_{B} and the power voltage V_{DD} to generate a secondary feedback signal V_{A} through resistors 337 and 338. The PWM circuit 350 generates the switching signal S_{W} in accordance with the secondary feedback signal V_{A}, the current feedback signal IFB, the off signal OFF and the power-on reset signal RST.

FIG. 8 shows a schematic circuit diagram illustrating the PWM circuit 350 according to one embodiment of the present invention. The PWM circuit 350 comprises an oscillator (OSC) 360, an inverter 351, comparators 365, 367, an AND gate 370, and a flip-flop 375. The oscillator 360 generates a clock signal PLS and a ramp signal RMP. The flip-flop 375 receives the clock signal PLS to periodically turn on the switching signal SW. The switching signal SW will be turned off when the ramp signal RMP is higher than the current feedback signal I_{FB} or the secondary feedback signal V_{A} in comparators 365, 367. The AND gate 370 also receives the off signal OFF through the inverter 351 to turn off the switching signal SW.

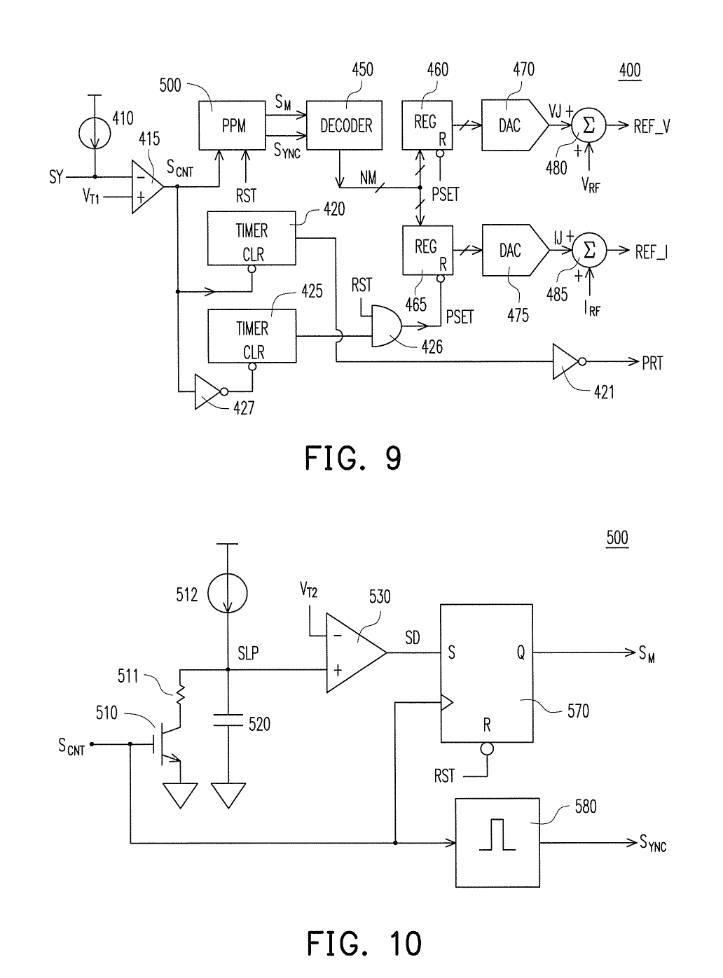

FIG. 9 shows a block diagram illustrating the programmable circuit 400 according to one embodiment of the present invention. The programmable circuit 400 comprises a current source 410, a comparator 415, a pulse-position modulation (PPM) circuit 500, timers 420 and 425, a digital decoder 450, inverters 421, 427, an AND gate 426, registers 460 and 465, DAC 470, 475, and adder circuits 480 and 485. The current source 410 is connected to pull high the control signal S_{Y}. The comparator 415 generates a pulse signal S_{CNT} when the control signal S_{Y} is lower than a threshold V_{T1}. The PPM circuit 500 generates a demodulated signal S_{M} and a synchronous signal S_{YNC} in response to the pulse signal S_{CNT}. The demodulated signal S_{M} and the synchronous signal S_{YNC} are coupled to a digital decoder 450 to generate a digital data N_{M}. The digital data N_{M} is stored into the register 460 and the register 465. The register 460 is coupled to a digital-to-analog converter (DAC) 470 for generating a voltage-adjusting signal V_{J}. The adder circuit 480 generates the reference signal REF_V by adding a reference signal V_{RF} and the voltage-adjusting signal V_{J}.

The register 465 is coupled to a digital-to-analog converter 475 for generating a current-adjusting signal IJ. The add circuit 485 generates the reference signal REF_I by adding a reference signal I and the current-adjusting signal I_{J}. Therefore, the reference signal REF_V and the reference signal REF_I are programmable by the micro-controller 80. The reflected voltage V_{S} of the transformer 10 is used for the over-voltage protection in the switching controller 300. The threshold of the over-voltage protection for output voltage V_{O} is programmable by the control circuit 100 in the secondary side of the transformer 10. Furthermore, the value of the output current I_{O} can be programmed by the control circuit 100 in the secondary side of the transformer 10.

The pulse signal S_{CNT} is further coupled to a timer 420 for detecting the pulse width of the pulse signal S_{CNT}. The protection signal PRT will be generated by the timer 420 through the inverter 421 if the pulse width of the pulse signal S_{CNT} is over a period T_{OV}. The protection signal PRT is configured to turn off the switching signal S_{W}. Because the control signal S_{X} (and the pulse signal S_{CNT}) will be generated greater than the period T_{OV} when the over-voltage of the output voltage V_{O} is detected by the control circuit 200 in the secondary side of the transformer 10, the switching signal SW will be turned off when the over-voltage of the output voltage V_{O} is detected.

Another timer 425 is configured to receive the pulse signal S_{CNT} through the inverter 427. The timer 425 will generate a reset signal PSET through the AND gate 426 when the pulse signal S_{CNT} is not generated over a specific period T_{OT}. The AND gate 426 receives the power-on reset signal RST and the output of the timer 425 to generate the reset signal PSET. The reset signal PSET is configured to clear the registers 460, 465 for resetting the value of the voltage-adjust signal V_{J} and the current-adjust signal IJ to the zero. Therefore, the reference signal REF_V will be set to a minimum value (V_{RF}) for the over-voltage protection when the control signal SX is not generated by the control circuit 100. Besides, the reference signal REF_I will be set to a minimum value (I_{RF}) for regulating the output current I_{O} when the control signal S_{X} is not generated by the control circuit 100 in time periodically. Therefore, if the micro-controller 80 is not operated properly, the threshold for the over-voltage protection and the reference signal for the output current regulation will be reset to a minimum value. Consequently, the control signal S_{X} generated by the control circuit 100 is used for the following situations.

(1) The control signal S_{X} is used for the over-voltage protection when the over-voltage is detected in the control circuit 100.

(2) The control signal S_{X} is used for the communication for setting the over-voltage threshold (REF_V) and the current limit threshold (REF_I) in the switching controller 300.

(3) The control signal S_{X} is used for resetting the timer 420 in the switching controller 300 to ensure the control circuit 100 is operated properly, otherwise the over-voltage threshold (REF_V) and the current reference signal (REF_I) of the switching controller 300 will be reset to the minimum value for protecting and regulating the power converter.

FIG. 10 shows a block diagram illustrating the pulse-position modulation circuit 500 in FIG. 9 according to one embodiment of the present invention. The PPM circuit 500 operates as a de-modulator for an input signal with the pulse-position modulation. The PPM circuit 500 includes a current source 512, a transistor 510, a resistor 511, a capacitor 520, a comparator 530, a flip-flop 570 and a pulse generation circuit 580. The current source 512 charges the capacitor 520. The pulse signal S_{CNT} is configured to discharge the capacitor 520 through the transistor 510 and the resistor 511. A slope signal SLP is generated by the capacitor 520. The comparator 530 generates a data signal S_{D} as the logic-high when the slope signal SLP is higher than a threshold V_{T2}. The data signal S_{D} will be latched into a flip-flip 570 in response to the pulse signal S_{CNT} for generating the demodulated signal S_{M}. The pulse signal S_{CNT} is further configured to generate the synchronous signal SYNC through the pulse generation circuit 580.

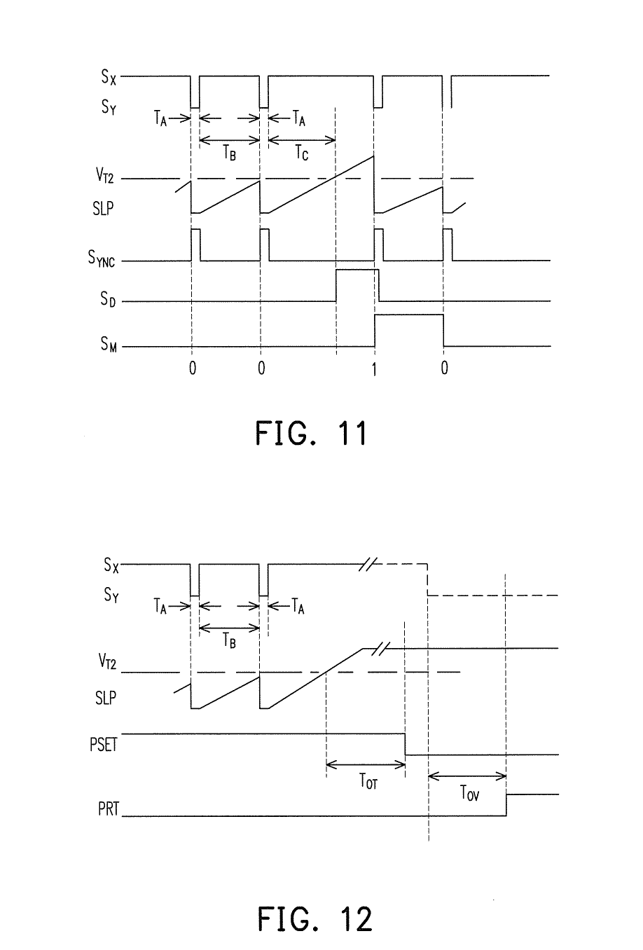

FIG. 11 shows the waveforms of the control signals S_{X}, S_{Y}, the slope signal SLP, the synchronous signal S_{YNC}, the data signal S_{D} and the demodulated signal S_{M} according to one embodiment of the present invention. The waveforms show the demodulated signal S_{M} is generated in accordance with the pulse position of the control signal S_{X}. In FIG. 11, a period T_{A} is referred to the disable period of the control signal SX. Periods T_{B} and T_{C} are referred to the periods when the control signal S_{X} is enabled and the slope signal SLP is not higher than the threshold V_{T2}.

FIG. 12 shows the waveforms of the control signals SX, SY, the reset signal PSET and the protection signal PRT according to one embodiment of the present invention. The reset signal PSET will be generated if the control signal SX is not generated over the specific period T_{OT}. The protection signal PRT will be generated if the pulse width of the control signal SX is greater than the period T_{OV}.

Although the present invention and the advantages thereof have been described in detail, it should be understood that various changes, substitutions, and alternations can be made therein without departing from the spirit and scope of the invention as defined by the appended claims. That is, the discussion included in this invention is intended to serve as a basic description. It should be understood that the specific discussion may not explicitly describe all embodiments possible; many alternatives are implicit. The generic nature of the invention may not fully explained and may not explicitly show that how each feature or element can actually be representative of a broader function or of a great variety of alternative or equivalent elements. Again, these are implicitly included in this disclosure. Neither the description nor the terminology is intended to limit the scope of the claims.

What is claimed is:

1. A circuit for controlling a programmable power converter, comprising:
a control circuit for generating a programmable voltage-reference signal for the power converter;
a feedback circuit configured to detect an output voltage of the power converter for generating a feedback signal in accordance with the programmable voltage-reference signal and the output voltage;
a switching controller for detecting a switching current of a transformer for generating a switching signal configured to switch the transformer for generating the output voltage and an output current of the power converter in accordance with the feedback signal and the switching current of the transformer;
a synchronous rectifier coupled to the transformer for generating the output voltage of the power converter; and
an opto-coupler for transferring the feedback signal from the control circuit to the switching controller,
wherein the control circuit is coupled to a secondary side of the transformer; the switching controller is coupled to a primary side of the transformer; the control circuit generates a driving signal configured to control the synchronous rectifier.

2. The circuit as claimed in claim 1, in which the control circuit comprising:
a communication interface for communicating with at least one external device.

3. The circuit as claimed in claim 1, in which the control circuit further generates a programmable digital code configured to generate the driving signal.

4. The circuit as claimed in claim 1, in which the switching controller configured to detect a reflected signal of the transformer for regulating the output current of the power converter in accordance with a demagnetizing time of the transformer.

5. The circuit as claimed in claim 1, in which the switching controller configured to detect a reflected signal for performing an over-voltage protection in the switching controller.

6. The circuit as claimed in claim 1, further comprising:
a second opto-coupler for transferring a control signal of the control circuit to the switching controller.

7. The circuit as claimed in claim 1, in which the control circuit comprising:
a digital-to-analog circuit generating an over-voltage threshold for an over-voltage protection in the control circuit;
an over-voltage protection circuit for generating an over-voltage signal by comparing the output voltage and the over-voltage threshold;
wherein the over-voltage signal is transferred to the switching controller through the second opto-coupler; the over-voltage threshold is reset to a minimum value of the over-voltage threshold in response to a power on of the power converter; the over-voltage signal is configured to disable the switching signal.

8. The circuit as claimed in claim 1, in which the programmable voltage-reference signal is reset to an initial value in response to the power on of the power converter.

9. The circuit as claimed in claim 1, further comprising:
a micro-controller for generating the programmable voltage-reference signal and the control signal,
wherein the control signal is configured to control the switching controller through the second opto-coupler.

10. The circuit as claimed in claim 9, in which the control circuit further comprising:
a timer for receiving the control signal from the micro-controller;
wherein the timer generates a time-out signal if the control signal is not generated in time periodically; the programmable voltage-reference signal and the programmable over-voltage threshold is reset to an initial value respectively in response to the time-out signal.

11. The circuit as claimed in claim 1, in which the control circuit further comprising:
an analog-to-digital converter for detecting the output voltage of the power converter,
wherein an output of the analog-to-digital converter is coupled to a micro-controller.

12. The circuit as claimed in claim 11, in which the control circuit detects an input voltage of the power converter through a synchronous rectifying circuit and the analog-to-digital converter.

13. The circuit as claimed in claim 1, in which the control circuit generates the control signal configured to program an over-voltage threshold signal in the switching controller for an over-voltage protection of the output voltage.

14. The circuit as claimed in claim 1, in which the control circuit generates a control signal configured to control a programmable current reference signal in the switching controller for regulating the output current.

15. The circuit as claimed in claim 14, in which the programmable current reference signal and the over-voltage threshold signal will be rest to an initial value respectively in response to an power on of the switching controller; and, the programmable current reference signal and the over-voltage threshold signal is rest to the initial value respectively if the control signal is not generated in time.

16. A method for controlling a power converter, comprising:
generating a programmable voltage-reference signal for the power converter;
detecting an output voltage of the power converter for generating a feedback signal in accordance with the programmable voltage-reference signal and the output voltage;
detecting a switching current of a transformer for generating a switching signal configured to switch the transformer for generating the output voltage and an output current of the power converter in accordance with the feedback signal and the switching current of the transformer; and
generating the output of the power converter by a synchronous rectifier of the power converter,
wherein a driving signal is generated for controlling the synchronous rectifier.
